(19) United States
(12) Patent Application Publication
(10) Pub. No.: US 2026/0186370 A1
(43) Pub. Date: Jul. 2, 2026

(54) VERTICAL CAVITY OPTICAL PARAMETRIC OSCILLATOR

(71) Applicant: NTT RESEARCH, INC., Sunnyvale, CA (US)

(72) Inventors: Thibault CHERVY, Sunnyvale, CA (US); Timothy MCKENNA, Sunnyvale, CA (US); Marc JANKOWSKI, Sunnyvale, CA (US); Edwin NG, Sunnyvale, CA (US); Yoshihisa YAMAMOTO, Sunnyvale, CA (US)

(73) Assignee: NTT RESEARCH, INC., Sunnyvale, CA (US)

(21) Appl. No.: 19/429,336

(22) Filed: Dec. 22, 2025

Related U.S. Application Data
(60) Provisional application No. 63/740,151, filed on Dec. 30, 2024.

(51) Int. Cl. G02F 1/39; G02F 1/35; G02F 1/355

(52) U.S. Cl. CPC G02F 1/392; G02F 1/3503; G02F 1/3532; G02F 1/3544; G02F 1/3551; G02F 2203/15

(57) ABSTRACT

In some embodiments, a vertical cavity optical parametric oscillator may be provided. The vertical cavity optical parametric oscillator may include a first mirror layer and a second mirror layer and a non-linear optical layer between the first mirror layer and the second mirror layer. The non-linear optical layer may be configured to resonate both a fundamental harmonic optical signal and a second harmonic optical signal. Each of the first mirror layer and the second mirror layer may provide reflecting surfaces for both the fundamental harmonic optical signal and the second harmonic optical signal to reflect back and forth within the non-linear optical layer.

### PRIORITY AND INCORPORATION BY REFERENCE

This application claims priority to U.S. Provisional Application Publication No. 63/740,151 entitled “Vertical Cavity Optical Parametric Oscillator” and filed Dec. 30, 2024, which has been incorporated in its entirety by reference.

### FIELD

This disclosure relates to photonic integrated circuits and particularly to vertical cavity optical parametric oscillators.

### BACKGROUND

The emerging field of photonic integrated circuits require parallel and reproducible device fabrication. In photonic integrated circuits, light is guided by waveguides that are typically fabricated by etching millimeter long and micrometer wide ridges out of transparent oxides. Such fabricated waveguides operate as optical circuits, which provide a non-linear operation at a low power budget. However, the conventional photonic integrated circuits still have several technical shortcomings. One major shortcoming is a low degree of connectivity because crossing waveguides typically lead to a large unwanted crosstalk and cause power losses. The crossing waveguides are problematic for optical parametric oscillator solvers such as coherent Ising machines and XY machines for which dense arrays of non-linear optical elements need to be connected to each other in reconfigurable ways. This limitation has been partially circumvented by relying on time-multiplexing, whereby a train of optical pulses circulating in a unique cavity encodes the different sites of a synthetic network. This solution however comes at the cost of additional latency in the optical solver, and requires sophisticated electronic readout and feedback (e.g. using multiple FPGAs). Furthermore, conventional photonic integrated circuits are generally bulky, with a footprint of the order of a few cm² limited by the bending losses of the waveguide, and therefore face challenges for high density integration at a large scale.

### SUMMARY

In some embodiments, a vertical cavity optical parametric oscillator may be provided. The vertical cavity optical parametric oscillator may include a first mirror layer and a second mirror layer and a non-linear optical layer between the first mirror layer and the second mirror layer. The non-linear optical layer may be configured to resonate both a fundamental harmonic optical signal and a second harmonic optical signal. Each of the first mirror layer and the second mirror layer may provide reflecting surfaces for both the fundamental harmonic optical signal and the second harmonic optical signal to reflect back and forth within the non-linear optical layer.

In some embodiments, method of performing an optical parametric oscillation may be provided. The method may include reflecting, by each of a first mirror layer and a second mirror layer of a vertical cavity parametric oscillator, a fundamental harmonic optical signal and a second harmonic optical signal back and forth within a non-linear optical layer of the vertical cavity parametric oscillator such that both the fundamental harmonic optical signal and the second harmonic optical signal resonate in the non-linear optical layer.

In some embodiments, a method of manufacturing a vertical cavity optical parametric oscillator may be provided. The method may include depositing a first mirror layer on a substrate. The method may also include depositing a non-linear optical layer on the first mirror layer. The method may further include depositing a second mirror layer on the non-linear optical layer. The non-linear optical layer may be configured to resonate both a fundamental harmonic optical signal and a second harmonic optical signal. Each of the first mirror layer and the second mirror layer may provide reflecting surfaces for both the fundamental harmonic optical signal and the second harmonic optical signal to reflect back and forth within the non-linear optical layer.

### BRIEF DESCRIPTION OF DRAWINGS

FIG. 1 shows an example vertical cavity optical parametric oscillator, according to example embodiments of this disclosure.

FIG. 2A shows an example of adjusting nonlinear polarization generated within a non-linear element of the vertical cavity optical parametric oscillator, according to example embodiments of this disclosure.

FIG. 2B shows another example of adjusting nonlinear polarization generated within the non-linear element of the vertical cavity optical parametric oscillator, according to example embodiments of this disclosure.

FIG. 3A shows an example of relative positioning of the non-linear element between a cavity front mirror and a cavity back mirror of the vertical cavity optical parametric oscillator, according to example embodiments of this disclosures.

FIG. 3B shows another example of relative positioning of the non-linear element between the cavity front mirror and the cavity back mirror of vertical cavity optical parametric oscillator, according to example embodiments of this disclosures.

FIG. 4 shows an example vertical cavity optical parametric oscillator array, according to example embodiments of this disclosure.

FIG. 5 shows an example of nearest neighbor coupling of vertical optical parametric oscillators, according to example embodiments of this disclosure.

FIG. 6 shows an example of programmable coupling of vertical optical parametric oscillators, according to example embodiments of this disclosure.

FIG. 7 shows a flow diagram of an example method of performing an optical parametric amplification, according to example embodiments of this disclosure.

FIG. 8 shows a flow diagram of an example method of fabricating a vertical cavity optical parametric oscillator, accordingly to example embodiments of this disclosure.

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments disclosed herein may provide a vertical cavity optical parametric oscillator. The disclosed vertical cavity optical parametric oscillator may not have the same connectivity issues—e.g., crossing waveguides—as the conventional photonic integrated circuits: the vertical cavity optical parametric oscillator may allow for a vertical injection of the optical signals and the vertical reading of the optical signals. That is, horizontal passing of the optical signals and therefore the necessity of having the crossing waveguides may be minimized. Additionally, the vertical cavity optical parametric oscillator has a smaller footprint compared to conventional photonic integrated circuits, and therefore amenable to production in scale. For example, multiple vertical cavity optical parametric oscillators may be fabricated on a single wafer. There is also a possibility of out-of-plane networking for coherent optical computing with arbitrary and reconfigurable connectivity between the components because, e.g., the vertical cavity optical parametric oscillator may allow for vertical injection and readings of the optical signals.

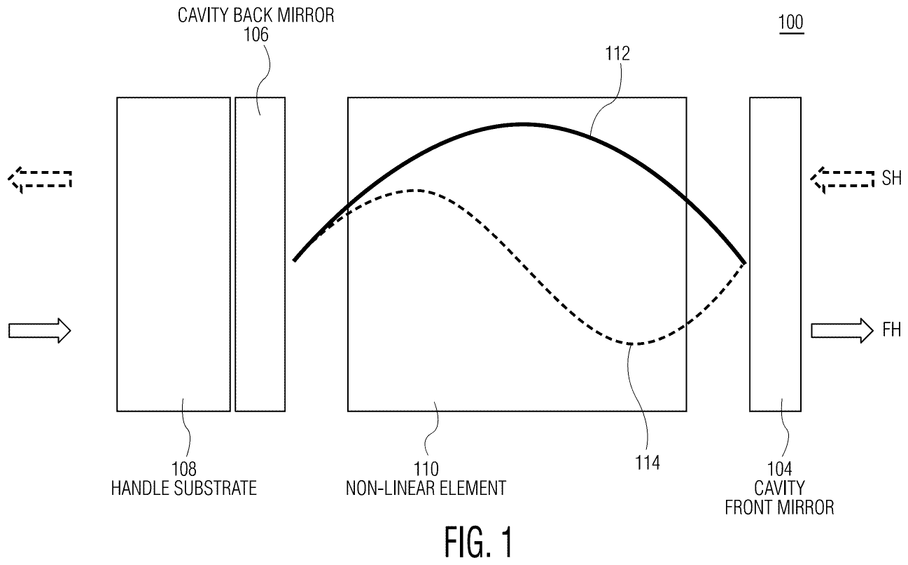

FIG. 1 shows an example vertical cavity optical parametric oscillator 100, according to example embodiments of this disclosure. As shown, the vertical cavity optical parametric oscillator 100 may include, among other components, a cavity front mirror 104 providing a reflecting surface, cavity back mirror 106 providing another reflecting surface, a non-linear element 110, and a handle substrate 108. It should however be understood that the components of the vertical cavity optical parametric oscillator 100 shown in FIG. 1 and described herein are merely examples, and optical cavities with additional, alternate, and fewer number of components should be considered within the scope of this disclosure.

In some embodiments, each of the cavity front mirror 104 and the cavity back mirror 106 may be formed by coatings on the handle substrate 108. In some embodiments, the coatings may be multi-layered, alternating between high refractive index material and a low refractive index material. In some embodiments, the coatings may be used to form distributed Bragg reflectors (DBRs) and therefore each of the cavity front mirror 104 and the cavity back mirror 106 may be DBRs. It should be noted that the terms “front” and “back” are just used for the ease of reading, e.g., the cavity front mirror 104 may face away from the handle substrate 108 and the cavity back mirror 106 may face the handle substrate, and should not be considered to a specific orientation of the vertical cavity optical parametric oscillator 100.

The non-linear element 110 may be formed by any type of material or crystal that may facilitate non-linear resonance of photons injected into the vertical cavity optical parametric oscillator 100. Such non-linear resonance may cause the vertical cavity optical parametric oscillator 100 to output photons at a different frequency than the injected photos. For example, the injected photons may be those of the blue-colored light, but the output photons may be of the red-colored light. In some embodiments, the non-linear element may be formed using second-order non-linear optical element. In some embodiments, the second order non-linear element 110 may be thin film Lithium Niobate (TFLN). Use of TFLN material is just but an example and other second-order non-linear optical materials should also be considered within the scope of this disclosure.

The handle substrate 108 may be representative any kind of substrate that may receive as layers of coatings the cavity back mirror 106 (e.g., as a first layer of coating), the non-linear element 110 (e.g., as a second layer of coating), and the cavity front mirror 104 (e.g., a third layer of coating). In some embodiments, the handle substrate 108 may form a wafer where multiple vertical cavity parametric oscillator 100 devices may be manufactured using the multiple layers of coating.

For a more efficient optical parametric oscillation, the vertical cavity optical parametric oscillator 100 may be configured to satisfy the following three conditions:

### Resonance

The electromagnetic field within the vertical cavity optical parametric oscillator 100 may have to satisfy the cavity resonance at both the fundamental harmonic (FH) frequency and a second harmonic (SH) frequency. As shown, both an FH field 112 (i.e., at the fundamental harmonic frequency) and an SH field 114 (i.e., at the second harmonic frequency) may have to be resonant within the non-linear element 110 based on the reflections from each of the cavity front mirror 104 and the cavity back mirror 106. Excitation any of the FH field 112 and the SH field 114—both resonant fields—may be performed to drive the other field.

### Phase Matching

During propagation through the non-linear element 110, the FH field 112 and the SH field 114 may de-phase due to the differences in refractive indices at the respective frequencies. For instance, the non-linear element 110 may provide a frequency dependent refractive index to cause the deviation of phases between the FH field 112 and the SH field 114 as they repeatedly reflect and propagate. The vertical cavity optical parametric oscillator 100 may be configured to perform a phase matching between the FH field 112 and the SH field 114 through polarization of non-linear element 110. In some embodiments, the non-linear element 110 may encompass coherence lengths of both the FH field 112 and the SH field 114. In these cases, a non-linear domain within the non-linear element 110 may be electrically inverted (also referred to as “poled”) to adjust nonlinear polarization (i.e., increase the non-linearity) generated in the non-linear element 110.

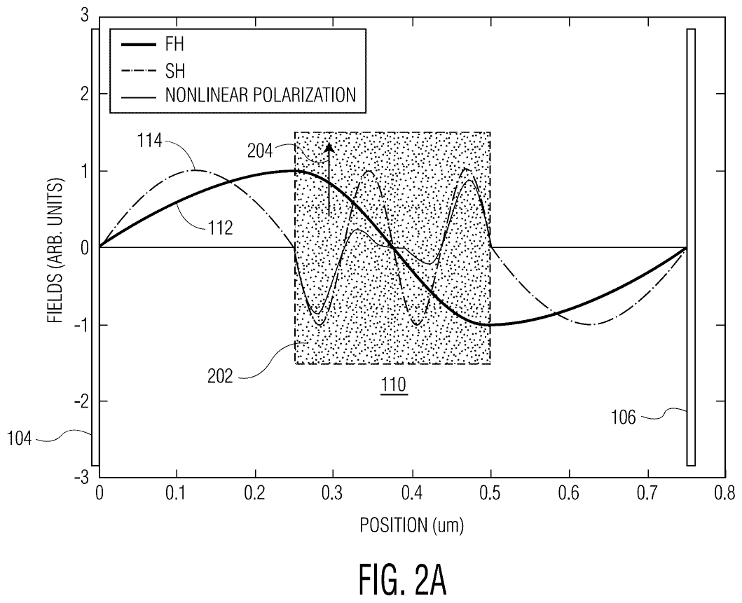

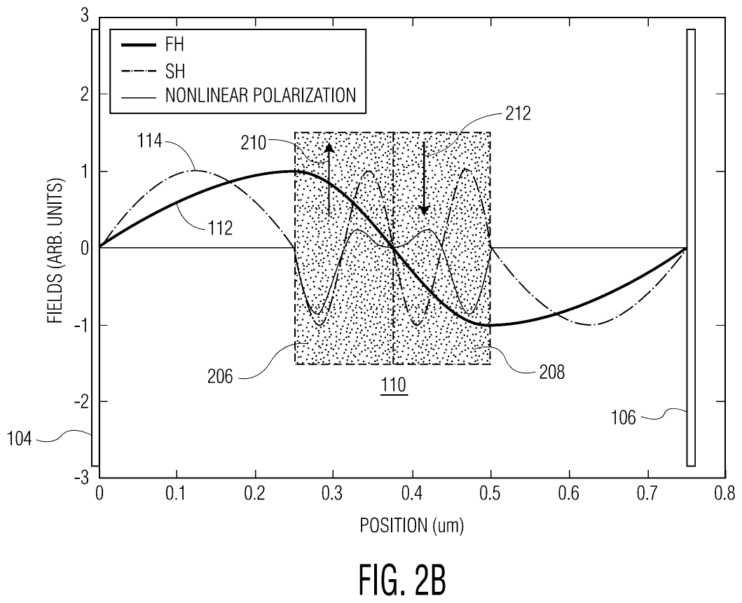

FIG. 2A shows an example of adjusting nonlinear polarization generated within the non-linear element 110 of the vertical cavity optical parametric oscillator 100, according to example embodiments of this disclosure. As shown, a single nonlinear domain 202 may have been used to generate a single pole 204. The single pole 204 may represent a nonperiodic polarization, which may be used to maximize the nonlinear polarization because for a periodic polarization, a non-linear effect from a previous pole may be canceled out by non-linear effect from a later pole. The nonperiodic polarization may adjust the phase(s) of one of more of the FH field 112 and the SH field 114. In some embodiments, periodic polarization may also be used. The phase adjustment may be used to bring the phases of the FH field 112 and the SH field 114 closer together to counteract the de-phasing effect imparted by the non-linear element 110.

FIG. 2B shows another example of adjusting nonlinear polarization generated within the non-linear element 110 of the vertical cavity optical parametric oscillator 100, according to example embodiments of this disclosure. As shown, two nonlinear domains 206, 208 may have been electrically inverted to generate corresponding two poles 210, 212. The two poles 210, 212 may represent a nonperiodic polarization because the polarization pattern of the two poles 210, 212 may not repeat periodically. As with single pole 204 describe above, the nonperiodic two poles 210, 212 also may be used to maximize the nonlinear polarization. The nonperiodic polarization may adjust the phase(s) of one of more of the FH field 112 and the SH field 114. In some embodiments, periodic polarization may also be used. The phase adjustment may be used to bring the phases of the FH field 112 and the SH field 114 closer together to counteract the de-phasing effect imparted by the non-linear element 110.

### Relative Phase of the Second Harmonic Field

The SH field 114 generated on a forward pass through the non-linear element 110 may constructively interfere with the SH field 114 generated on the backward pass after reflection of the cavity back mirror 106. If the interference is destructive, the SH field 114 will cancel out thereby decreasing the utility of the vertical cavity optical parametric oscillator 100. Therefore, the non-linear element 110 relative to the cavity front mirror 104 and the cavity back mirror 106 may be configured by adjusting the distance between the cavity front mirror 104 and the cavity back mirror 106 and the relative positioning of the non-linear element 110. The adjustment may be performed by using di-electric spacers (not shown) between the cavity front mirror 104 and the non-linear element 110 and/or the cavity back mirror 106 and the non-linear element 110. The adjustment—providing a desired positioning of the non-linear element vis-à-vis the cavity front mirror 104 and the cavity back mirror 106—may allow for a constructive interference of the forward and backward passes of the SH field 114, as described below.

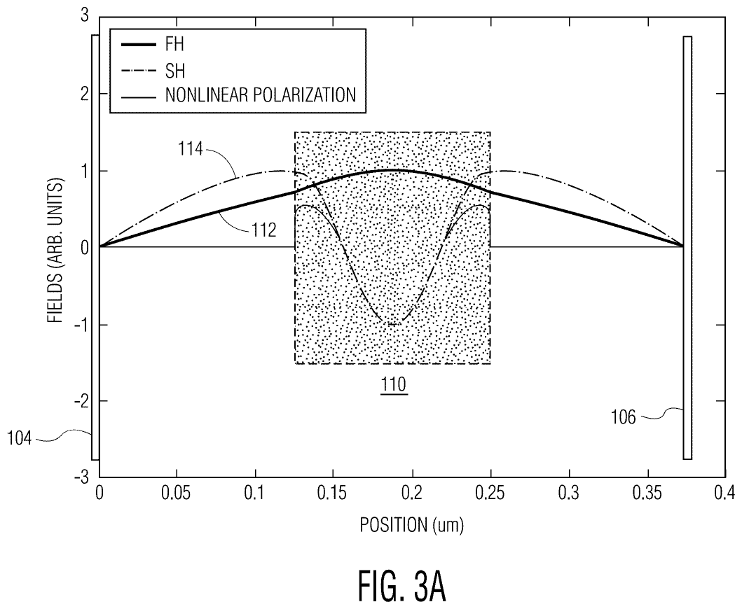

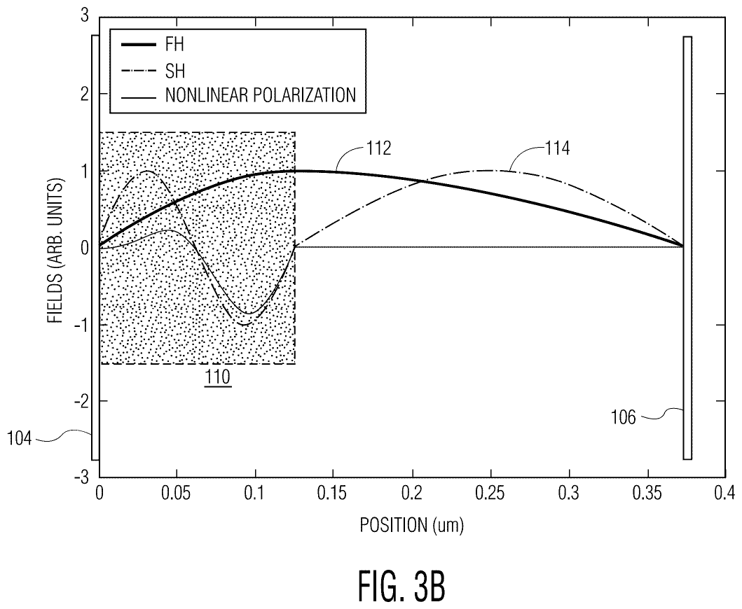

FIG. 3A shows an example of relative positioning of the non-linear element 110 between the cavity front mirror 104 and the cavity back mirror 106, according to example embodiments of this disclosures. As shown, the FH field 112 and the SH field 114 may overlap within the non-linear element 110. Additionally, the SH field 114 may further constructively interfere within the non-linear element 110.

FIG. 3B shows another example of relative positioning of the non-linear element 110 between the cavity front mirror 104 and the cavity back mirror 106, according to example embodiments of this disclosures. As shown, the FH field 112 and the SH field 114 may overlap within the non-linear element 110. Additionally, the SH field 114 may further constructively interfere within the non-linear element 110.

Therefore, embodiments disclosed herein may realize resonance within the vertical cavity optical parametric oscillator 100 by configuring electrical domains to achieve phase matching and controlling relative phases of the SH field 114 based on the relative positioning of the cavity front mirror 104, cavity back mirror 106, and non-linear element 110. In some embodiments, additional configurability (or tuning) may be provided by temperature control. For example, traces of gold (not shown) may be incorporated into vertical cavity optical parametric oscillator 100 and electric current passing through the traces may generate heat that may configure the refractive index of the non-linear element 110.

The configuration to achieve one or more of the resonance, phase matching, and relative phase of the SH field 114 may be performed any type of manufacturing technology. For example, a desired resonance can be achieved by adjusting the length of the vertical cavity optical parametric oscillator 100. In some embodiments, the FH field 112 may in the telecommunication wavelength (e.g., 1560 nm) and the SH field 114 may in the infrared wavelength (e.g., 780 nm). The vertical cavity optical parametric oscillator 100 may be sized to be 10 micrometers in length to achieve resonances in both the telecommunication wavelength as the FH field 112 and the infrared wavelength as the SH field 114. Alternatively, the desired resonance can be achieved by growing (or thinning) the non-linear element 110 to a desired thickness, prior to closing the cavity with the cavity front mirror 104, e.g., by using wafer bonding and wafer lapping processes. The total intra-cavity thickness, e.g., the thickness of the non-linear element 110 may be calculated by the refractive indices and reflection phases for the FH field 112 and the SH field 114. The reflection phases may be controlled by using different-layered DBRs as one or more of the cavity back mirror 106 and cavity front mirror 104.

In some embodiments, the phase matching can be achieved by periodic polarization of the non-linear element 110 along the cavity growth direction using side electrodes, by wafer bonding non-linear crystals with alternating crystals, and/or by wafer bonding non-linear crystals thinner than the coherence length. In some embodiments, the desired relative phase of the SH field 114 may be achieved by using intra-cavity dielectric spacer to keep the non-linear element 110 at a desired position with respect to the cavity front mirror 104 and the cavity back mirror 106.

Additionally, multiple vertical cavity optical parametric oscillators 100 may be manufactured in within a single wafer, thereby making the manufacturing process more efficient as well.

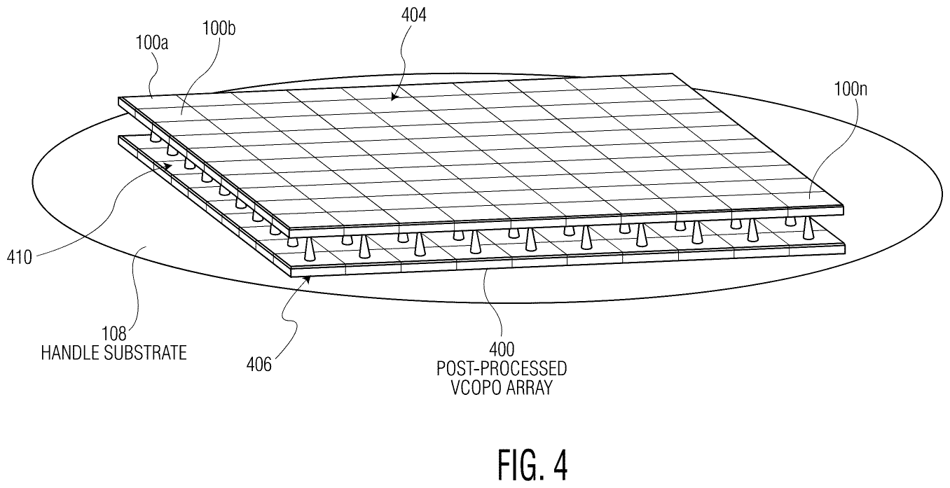

FIG. 4 shows an example vertical cavity optical parametric oscillator array 400, according to example embodiments of this disclosure. As shown, the vertical cavity optical parametric oscillator array 400 may be formed on a handle substrate 108 forming a single wafer where multiple vertical cavity optical parametric oscillators 100a-100n may be formed. The vertical cavity optical parametric oscillator array 400 may be formed on a single manufacturing run that coats the handle substrate 108 with multiple layers: a first layer 406 forming the cavity back mirror 106, a second layer 410 forming the non-linear element 110, and a third layer 404 forming the cavity front mirror 104 of each of the vertical cavity optical parametric oscillators 100a-100n. In some embodiments, the manufacturing process may vary the coatings for a desired positing of the non-linear element 110 with respect to the corresponding cavity front mirror 104 and cavity back mirror 106.

Because each of the vertical cavity optical parametric oscillators 100a-100n has a smaller footprint (e.g., in the order of μm²), large and dense arrays of vertical parametric oscillators 100a-100n can be constructed as a non-linear display surface. For example, the vertical cavity optical parametric oscillator array 400 may form a non-linear display surface where each of the vertical parametric oscillators 100a-100n with corresponding vertical emitting capability may be a pixel.

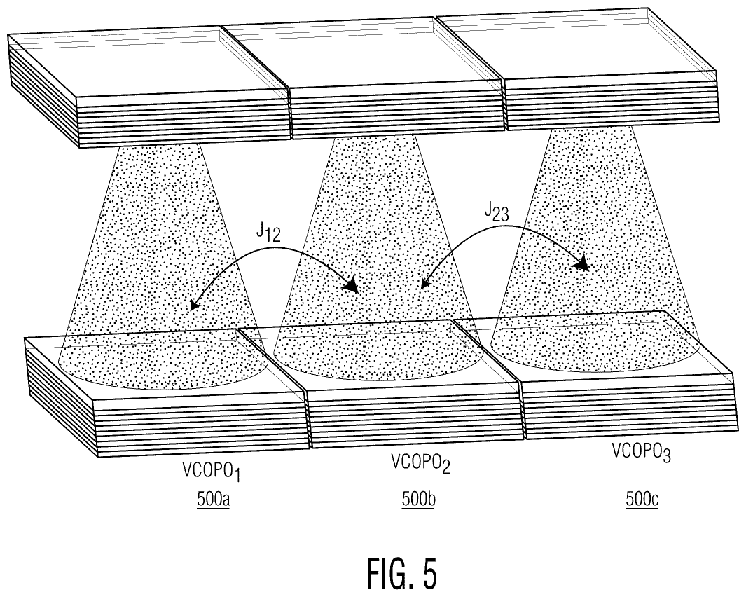

FIG. 5 shows an example of nearest neighbor coupling of vertical optical parametric oscillators, according to example embodiments of this disclosure. For example purposes only, three vertical optical parametric oscillators 500a, 500b, 500c are shown. Vertical optical parametric oscillator 500a may be the nearest neighbor to vertical optical parametric oscillator 500b and vertical optical parametric oscillator 500b may be the nearest neighbor to vertical optical parametric oscillator 500c. The coupling may be due to the leakage of radiation (forming the corresponding FH fields and SH fields) to the nearest neighbors: vertical optical parametric oscillator 100a and vertical optical parametric oscillator 500b may couple forming a coupling term J₁₂ and vertical optical parametric oscillator 500b and vertical optical parametric oscillator 500c may couple forming a coupling term J₂₃.

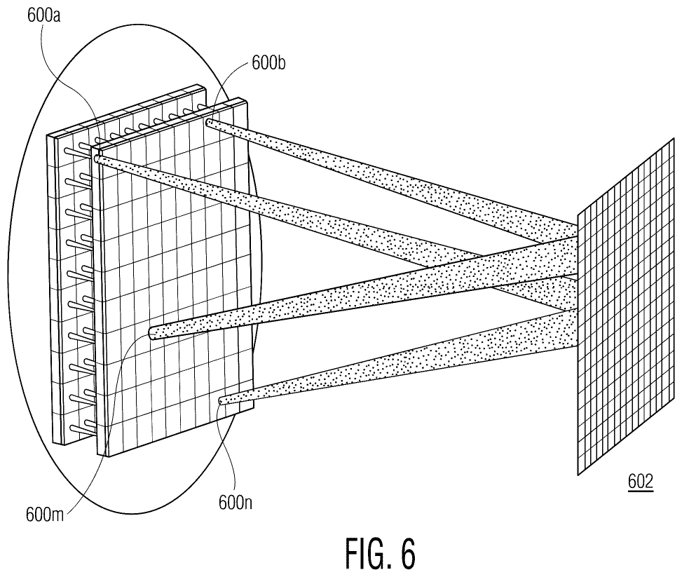

FIG. 6 shows an example of programmable coupling of vertical optical parametric oscillators, according to example embodiments of this disclosure. The programmable coupling may use free space optics, e.g., a mirror array 602, to couple vertical optical parametric oscillators by directing an emission of one vertical optical parametric oscillator to another vertical optical parametric oscillator. For example, the mirror array may direct the emission of vertical optical parametric oscillator 600a to vertical optical parametric oscillator 600n (or vice versa) and emission of vertical optical parametric oscillator 600b to vertical optical parametric oscillator 600m. Allowing for programmable coupling through free space optics may not have the drawbacks of crossing waveguides of conventional photonic circuits.

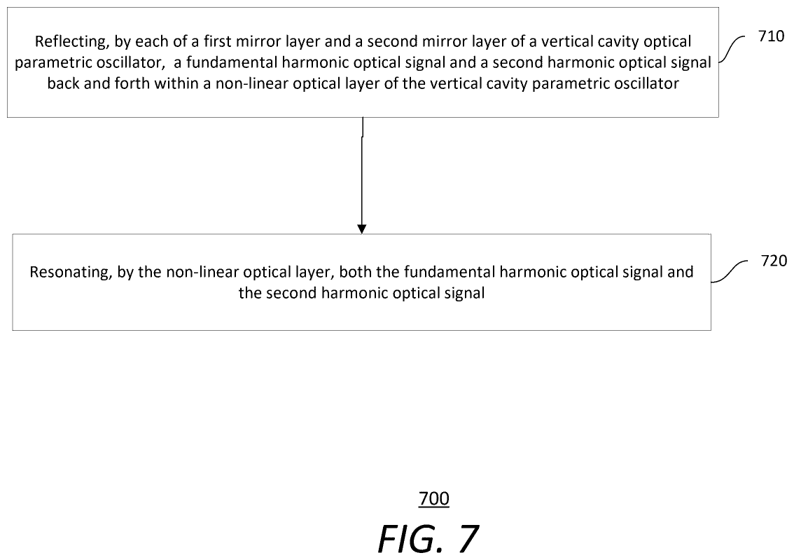

FIG. 7 shows a flow diagram of an example method 700 of performing an optical parametric amplification, according to example embodiments of this disclosure. The optical parametric amplification may be performed by a vertical cavity optical parametric oscillator 100 as described in reference to FIG. 1. In some embodiments, the vertical cavity optical parametric oscillator 100 may be a part of the vertical cavity optical parametric oscillator array 400. The sequential listing of the steps 710, 720 is just for ease of explanation and the steps 710, 720 may be performed simultaneously.

At step 710, each of a first mirror layer and a second mirror layer of the vertical cavity optical parametric oscillator 100 may reflect both a fundamental harmonic optical signal and a second harmonic optical signal back and forth within a non-linear optical layer of the vertical cavity optical parametric oscillator.

At step 720, a non-linear optical layer between the first mirror layer and the second mirror layer may resonate a fundamental harmonic optical signal and a second harmonic optical signal based on the reflections by the first mirror layer and the second mirror layer. In some embodiments, the fundamental harmonic optical signal may be in the telecom frequency (e.g., with wavelength of 1560 nm) and the second harmonic optical signal may be in the infrared frequency (e.g., with wavelength of 780 nm).

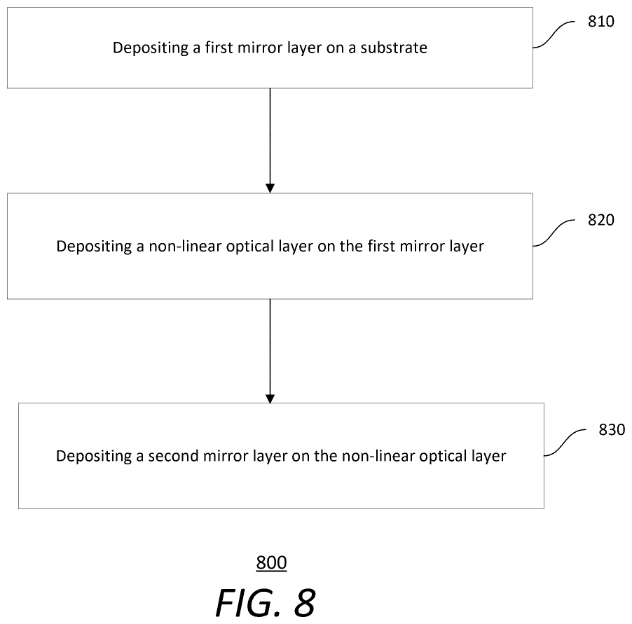

FIG. 8 shows a flow diagram of an example method 800 of fabricating a vertical cavity optical parametric oscillator, accordingly to example embodiments of this disclosure. In some embodiments, the method 800 may be used to fabricate a vertical cavity optical parametric oscillator array 400 comprising multiple vertical cavity optical parametric oscillators 100.

At step 810, a first mirror layer may be deposited on a substrate. The substrate may form a single wafer. In some embodiments, the first mirror layer may be formed by a DBR.

At step 820, a non-linear optical layer may be deposited on the first mirror layer. In some embodiments, the non-linear optical layer may be formed by TFLN.

At step 830, a second mirror layer may be deposited on the non-linear optical layer. In some embodiments, the second mirror layer may also be formed by a DBR.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A vertical cavity optical parametric oscillator comprising:
a first mirror layer and a second mirror layer; and
a non-linear optical layer between the first mirror layer and the second mirror layer,
the non-linear optical layer configured to resonate both a fundamental harmonic optical signal and a second harmonic optical signal, and
each of the first mirror layer and the second mirror layer providing reflecting surfaces for both the fundamental harmonic optical signal and the second harmonic optical signal to reflect back and forth within the non-linear optical layer.

2. The vertical cavity optical parametric oscillator of claim 1, wherein the non-linear optical layer is formed by a thin film Lithium Niobate.

3. The vertical cavity optical parametric oscillator of claim 1, wherein a length of the non-linear optical layer is tuned to resonate both the fundamental harmonic optical signal and the second harmonic optical signal.

4. The vertical cavity optical parametric oscillator of claim 1, wherein the fundamental harmonic optical signal is within a telecommunications wavelength and the second harmonic optical signal is within an infrared wavelength.

5. The vertical cavity optical parametric oscillator of claim 1, wherein the non-linear optical layer is polarized to perform a phase matching between the fundamental harmonic optical signal and the second harmonic optical signal.

6. The vertical cavity optical parametric oscillator of claim 5, wherein the non-linear optical layer is polarized nonperiodically.

7. The vertical cavity optical parametric oscillator of claim 1, wherein the non-linear optical layer is configured to adjust phases between different passes of the second harmonic optical signal.

8. The vertical cavity optical parametric oscillator of claim 7, wherein to adjust the phases between the different passes of the second harmonic optical signal, the non-linear optical layer is positioned at a predetermined location between the first mirror layer and the second mirror layer.

9. The vertical cavity optical parametric oscillator of claim 1, wherein at least one of the first mirror layer and the second mirror layer comprises a distributed Bragg reflector.

10. The vertical cavity optical parametric oscillator of claim 1, wherein at least one dimension of the vertical cavity optical parametric oscillator is approximately 10 micrometers.

11. A method of performing an optical parametric oscillation, the method comprising:
reflecting, by each of a first mirror layer and a second mirror layer of a vertical cavity parametric oscillator, a fundamental harmonic optical signal and a second harmonic optical signal back and forth within a non-linear optical layer of the vertical cavity parametric oscillator such that both the fundamental harmonic optical signal and the second harmonic optical signal resonate in the non-linear optical layer.

12. The method of claim 11, wherein the non-linear optical layer is formed by a thin film Lithium Niobate.

13. The method of claim 11, wherein a length of non-linear optical layer is tuned to resonate both the fundamental harmonic optical signal and the second harmonic optical signal.

14. The method of claim 11, wherein the fundamental harmonic optical signal is within a telecommunications wavelength and the second harmonic optical signal is within an infrared wavelength.

15. The method of claim 11, further comprising:
performing, by a polarized domain within the non-linear optical layer, a phase matching between the fundamental harmonic optical signal and the second harmonic optical signal.

16. The method of claim 15, wherein the polarized domain is polarized nonperiodically.

17. The method of claim 11, further comprising:
adjusting, by the non-linear optical layer, phases between different passes of the second harmonic optical signal.

18. The method of claim 17, wherein to adjust the phases between the different passes of the second harmonic optical signal, the non-linear optical layer is positioned at a predetermined location between the first mirror layer and the second mirror layer.

19. A method of manufacturing a vertical cavity optical parametric oscillator, the method comprising:
depositing a first mirror layer on a substrate;
depositing a non-linear optical layer on the first mirror layer; and
depositing a second mirror layer on the non-linear optical layer,
the non-linear optical layer configured to resonate both a fundamental harmonic optical signal and a second harmonic optical signal, and
each of the first mirror layer and the second mirror layer providing reflecting surfaces for both the fundamental harmonic optical signal and the second harmonic optical signal to reflect back and forth within the non-linear optical layer.

20. The method of claim 19, wherein the non-linear optical layer is formed by a thin film Lithium Niobate.
